(19) United States
(12) Patent Application Publication
(10) Pub. No.: US 2007/0199044 A1
(43) Pub. Date: Aug. 23, 2007

(54) SYSTEMS AND METHODS FOR DISTRIBUTED SECURITY POLICY MANAGEMENT

(75) Inventor: William A. Hughes, Mankato, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Samsung Electronics Co., Ltd., Gyeonggi-Do (KR)

(21) Appl. No.: 11/379,371

(22) Filed: Apr. 19, 2006

Related U.S. Application Data
(60) Provisional application No. 60/743,312, filed on Feb. 17, 2006.

(51) Int. Cl. H04L 9/00

(52) U.S. Cl. 726/1

(57) ABSTRACT

In an embodiment, a system for distributed security policy management is described. The system may include, a security policy server, a network server at a client network and one or more client workstations on the client network. In an embodiment, the security policy server is configured to receive updates to one or more security policies and distribute security policy objects to one or more network servers. In another embodiment, the network server is configured to receive security policy objects and distribute the security policy objects to the one or more client workstations. In a further embodiment, methods for maintaining security policies for one or more client networks are described.

### RELATED APPLICATION

This application claims the benefit of U.S. Provisional Application Ser. No. 60/743,312 filed Feb. 17, 2006, which application is incorporated herein by reference.

### TECHNICAL FIELD

Embodiments of the present invention relate to security policy management of one or more workstations and more particularly to distributed security policy management.

### BACKGROUND

Administrators of computer networks face new challenges every day in the administration and maintenance of those networks. Just the logistical challenges involved in purchasing, updating and deploying workstations to their users is time-consuming enough. Add to that requirement, the sometimes constant calls for support from those users, it seems there are not enough hours in the day to keep the network running. Some estimates place the optimum number of computer support people per users to be as high as one support person for every three or four employees.

Operating system developers release updates to their operating systems at least once a month. Sometimes these updates are patches needed for newly discovered security vulnerabilities. Add to that the updates to the actual operating system itself, promising increased stability and performance, it is hard to keep those workstations up to date. Further exacerbating the problem are the numerous software applications installed on those workstations. The developers of those products are also updating those products, promising increased stability and performance.

The bottom line for many computer support departments is that their personnel have little time to maintain familiarity with security vulnerabilities, let alone tailoring security levels to each of their various users. And in the case of small computer networks, such as at small businesses, the personnel assigned to do computer support also have other duties assigned to them, the problem is further magnified.

One solution for small companies is the out-sourcing of computer support. This typically involves contracting a small computer support firm to perform all the functions of an in-house computer support department. However, one of the downsides of such an arrangement is that the out-sourcing firm will typically have little to no appreciation for the specific requirements of individual users at the company and will instead use blanket policies for all users. This may work, on some level, but the user satisfaction with such an arrangement is typically very poor.

### BRIEF DESCRIPTION OF THE DRAWINGS

Embodiments are illustrated by way of example and not limitation in the figures of the accompanying drawings, in which like references indicate similar elements and in which:

FIG. 1 shows a high level block diagram of a system for providing centralized security policy management;

FIG. 2A shows a high level block diagram of an apparatus for updating security policies, in accordance with an example embodiment;

FIG. 2B shows a more detailed block diagram of an apparatus for updating security policies, in accordance with an example embodiment;

FIG. 3A shows a block diagram of an apparatus for distribution of security policy objects on a client network;

FIG. 3B shows a more detailed block diagram of an apparatus for distribution of security policy objects on a client network;

FIG. 4 shows a flowchart of a method of providing centralized security policy management to one or more client networks, in accordance with an example embodiment;

FIG. 5 shows a flowchart of a method of providing network services and tailored security objects to one or more client workstations on a client network, in accordance with an example embodiment;

FIG. 6 shows a flowchart of a method of providing tailored centralized security policy management to one or more client networks, in accordance with an example embodiment;

FIG. 7 shows a block diagram of a client network system, in accordance with an example embodiment; and

FIG. 8 shows a block diagram of a machine including instructions to perform any one or more of the methodologies described herein.

### DETAILED DESCRIPTION

In the following detailed description of example embodiments, reference is made to the accompanying drawings which form a part hereof, and in which is shown, by way of illustration, specific embodiments in which the example method, apparatus and system may be practiced. It is to be understood that other embodiments may be utilized and structural changes may be made without departing from the scope of this description.

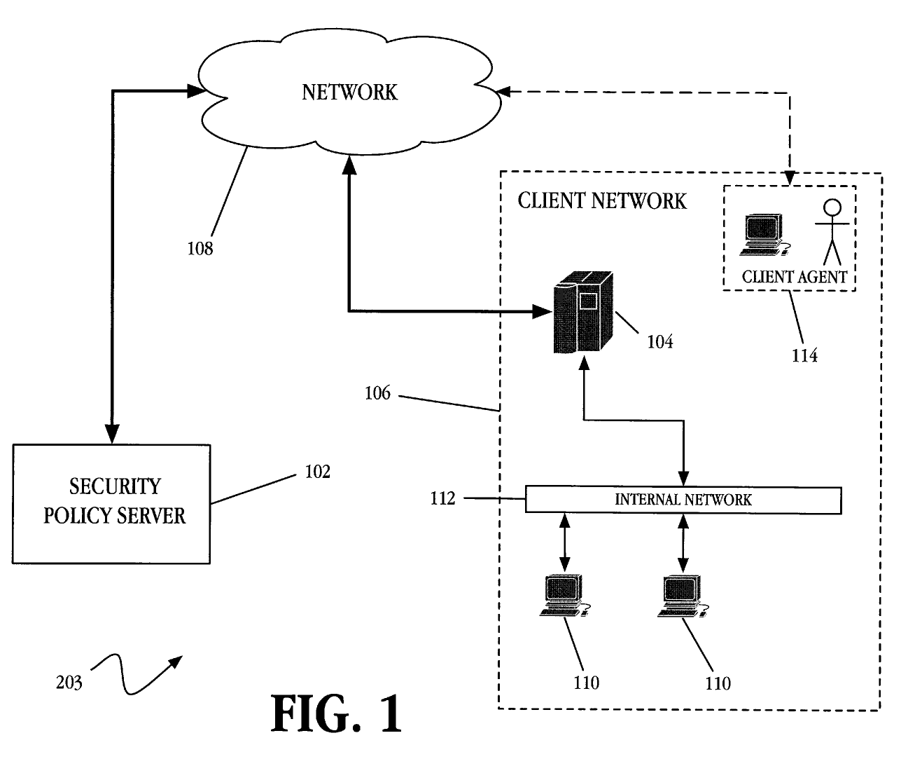

FIG. 1 shows a high level block diagram of a system for providing centralized security policy management. In an embodiment, the system 100 includes a security policy server 102 and network server 104 located on client network 106. The network server 104 is communicatively coupled to the security policy server 102 across a network 108, such as the Internet. The client network 106 includes one or more client workstations 110 coupled to the network server 104 through an internal network 112. The client network 106 additionally includes, in one embodiment, a client agent 114.

The network server 104, in one embodiment, provides network services to the one or more client workstations 110. Network services include, without limitation, internet connection, domain services, domain name resolution, and the like. The internal network may include, without limitation, a wired ethernet network, a wireless network, modem pool, or a Virtual Private Network providing client network-like functionality to remotely located client workstations. In one embodiment, each client workstation attempting to access network resources is required to authenticate to the network server. Following successful authentication, the client workstation is allowed access to those network resources. In a further embodiment, during the authentication process a software object may be auto-installed at the client workstation, the software object transferred from the network server 104 to the client workstation. In one embodiment, the software object is a security policy object stored on the network server 104. In an alternate embodiment, the network server requests the security policy object from the security policy server at the time of the client authentication and transfers the received security policy object to the client workstation. In yet another embodiment, the network server 104 receives periodic updates to a store of security policy objects from the security policy server 102. In such an arrangement, the network server 104 maintains a data store of security policy objects applicable to the client workstations connected to the internal network.

The security policy server 102, in one embodiment, is configured to maintain a data store of security policy objects. These security policy objects are configured to enforce one or more security policies. The one or more security policies are tailored to individual users of the client workstations, or the client workstations themselves. Some examples of security policies include, without limitation, application launching restrictions, file opening restrictions, connected time limits, web site access restrictions, and the like.

The client agent 114 is a special case of the client workstation, in an embodiment. The client agent 114 may be connected to the internal network as any other client workstation. The client agent 114 may also be connected to the network 108 through other means such as a personal internet access account. In either case, the client agent 114 is a security administrator of the client network 106, in an embodiment. One of the challenges in providing for proper security on any network is maintaining an up to date competency in security trends and best practices. For small to medium sized networks, the ability of any Information Technology (IT) professional to do this in an efficient manner is severely compromised by their need to provide overall troubleshooting support to their entire network. A result of this is that they are ill-equipped to tailor security policies for individual users, much less install special security software on each individual client workstation. One advantage of embodiments of the present invention is that the client agent 114 need not spend excessive time at an individual client workstation implementing security policy for that client workstation. In embodiments of the present invention, whenever a client workstation logs into the internal network, as part of the authentication of that client workstation, a security policy object is executed on the client workstations. The security policy object implements the security policies set by the client agent. The client agent 114 is able to set these security policies by communicating with the security policy server across the network, in one embodiment. In an alternate embodiment, the security policy server 102 is implemented at the client network. In such an arrangement, the client agent logs into the security policy server 102 on the client network. This arrangement provides for more local control, and could be used where the client network is perhaps a large network and the IT professionals are more skilled at implementing and maintaining complex security policies.

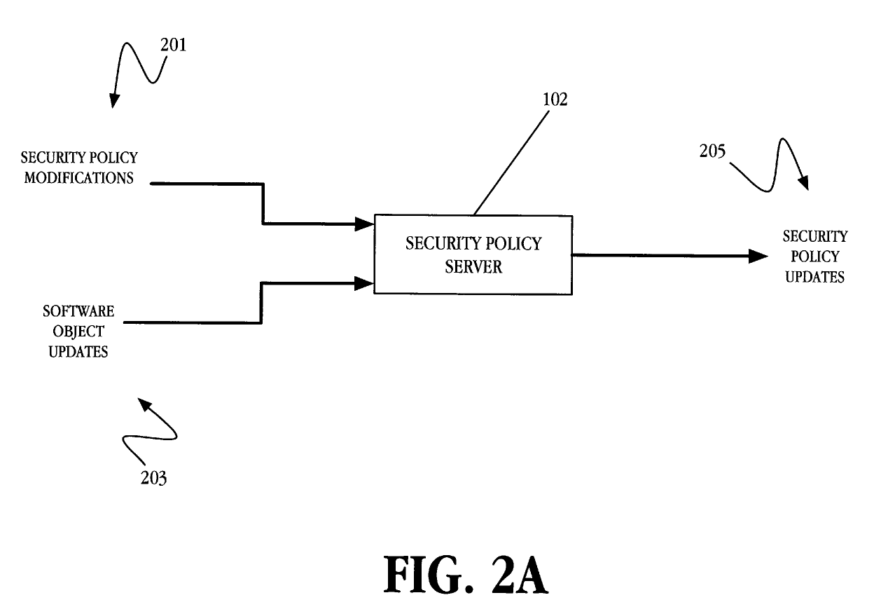

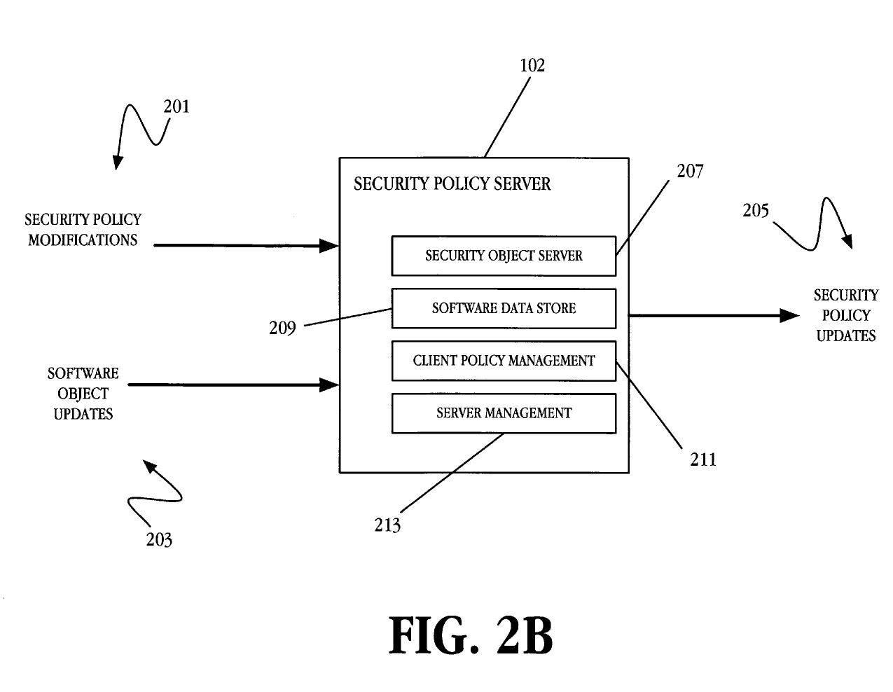

FIG. 2A shows a high level block diagram of an apparatus for updating security policies, in accordance with an example embodiment. The security policy server 102 receives one or two inputs. In an embodiment, the security policy server 102 receives security policy modifications 201. In another embodiment, the security policy server 102 receives software object updates 203. In yet another embodiment, the security policy server receives both security policy modifications 201 and software object updates 203. Using these inputs, the security policy server 102 configures one or more security policy objects and outputs security policy object updates 205.

The security policy server, in one embodiment, receives security policy modifications 201. Security policy modifications 201 include any change in a security policy implemented at a client network. Security policy includes, without limitation, application launching restrictions, filed download restrictions, configuration of open ports on a workstations, and the like. In a broader senses, a security policy can be considered to be any setting that intentionally allows or denies a user access to applications or files either on their local workstation or over the network. As will be discussed below, workstation includes any computer used by a user. The security policy modifications 201 may be received by an operator of the security policy server, in one embodiment. In such an arrangement the operator of the security policy server may be under contract to provide security support to the client network, as discussed above with respect to FIG. 1. In this example, the operator of the security policy server receives some indication from the client network as to general security policies implemented on the client network. For example, there could be a requirement that all users have no access to email applications on their workstations. The operator, in this example, would modify the security policy to affect that change.

Additionally, an agent of the client network may access the security policy server 102 and affect changes to the security policies operating on that client network. The client agent may access the security policy through any means suitable, including, without limitation, secure web-client applications, dedicated client-server applications, and the like. Through such access, the client agent may apply very broad security policies to the users on the client network, very granular security policies or some combination, to the users on the client network. One example of a broad security policy may be disabling all file transfer capabilities on the client workstation. One example of a very granular security policy may be disabling file transfers to the client workstation from a specific domain, such as aol.com. Restrictions such as these are well known in the art and discussion of specific restrictions, implemented by a policy on the workstation, is outside the scope of the present discussion. Any restrictions on the usage of a workstation are considered restrictions implemented by a security policy on the client workstation and are considered to be within the scope of the present application.

The security policy server 102 may additionally receive, in an embodiment, software object updates 203. As will be discussed below, the implementation of the security policy is accomplished by the installation of a software object. As the applications, most notably the operating system application, are updated periodically by their developers, it may be necessary to modify the software code of the installed software object accordingly. In such instances, an update to the software objects would be received by the security policy server, in any suitable manner as are well known in the art.

The security policy server 102, using either or both of the security policy modifications 201 and software object updates 203, configures and sends security policy updates 205 to one or more client networks. The security policy updates implement the security policies as modified. The security policy updates may take the form of software instructions implemented by a client network server, such as the network server 104 described above with respect to FIG. 1, where the software instructions cause a security policy object stored on the client network server to be modified. The security policy updates may also include, in an alternate embodiment, a new security policy object, which when received by the network server, replaces the previous stored security object totally.

FIG. 2B shows a more detailed block diagram of an apparatus for updating security policies, in accordance with an example embodiment. As discussed above with respect to FIG. 2A, the security policy server 102 receives either security policy modifications 201 or software object updates 203, or both, as inputs and outputs security policy object updates 205 to one or more client network locations. In an embodiment, the security policy server 102 includes a security policy object server 207, a software data store 209, a client policy management module 211 and a server management module 213.

The software modules described with respect to FIG. 2B are separated for the purposes of clarity and do not necessarily represent a difference in structural arrangement of the software modules. As such, one or more of the functions described here with respect to each of the software modules may be combined into a single software module.

In an embodiment, the security object server 207 is configured to send security policy updates to one or more network servers operating on one or more client networks, as discussed above with respect to FIG. 1. The security policy updates include, in some embodiments, software instructions intended to cause a software object stored on the one or more network servers to be modified according to the software instructions, or a software object that when received by the one or more network servers will replace a previously stored software object.

In an embodiment, the software data store 209 is configured to store one or more security policy objects. The security policy objects are installable software packages which when received by a workstation are installed on the workstation without any intervention by the user of the workstation.

In an embodiment, the client policy management module 211 is configured to provide access to a client agent or an operator of the security policy server. In either example, the client policy management module 211 provides them the ability to access the security policies implemented for one of the one or more client networks supported by the security policy server 102.

In an embodiment, the server management module 213 is configured to receive updates from an operator of the security policy server. In such an arrangement, the server management module 213 is configured to provide a user interface to the operator such that software updates to the stored security policy objects can be affected. Additionally, in other embodiments, the server management module 213 is configured to receive updates to one or more security policies from the operator, the one or more security policies, in this context, refer to general security vulnerabilities that have equal applicability to all client networks supported by the security policy server 102.

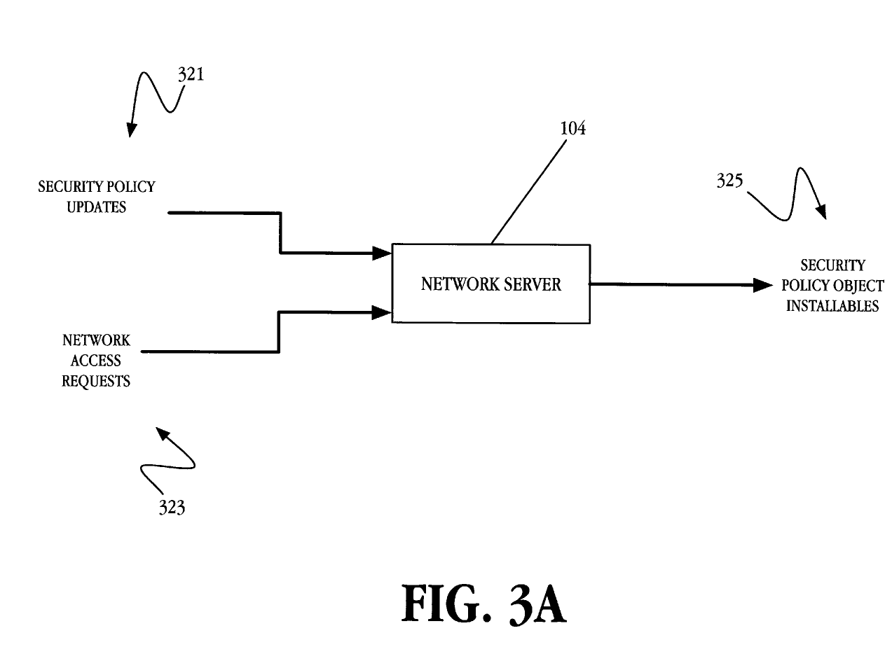

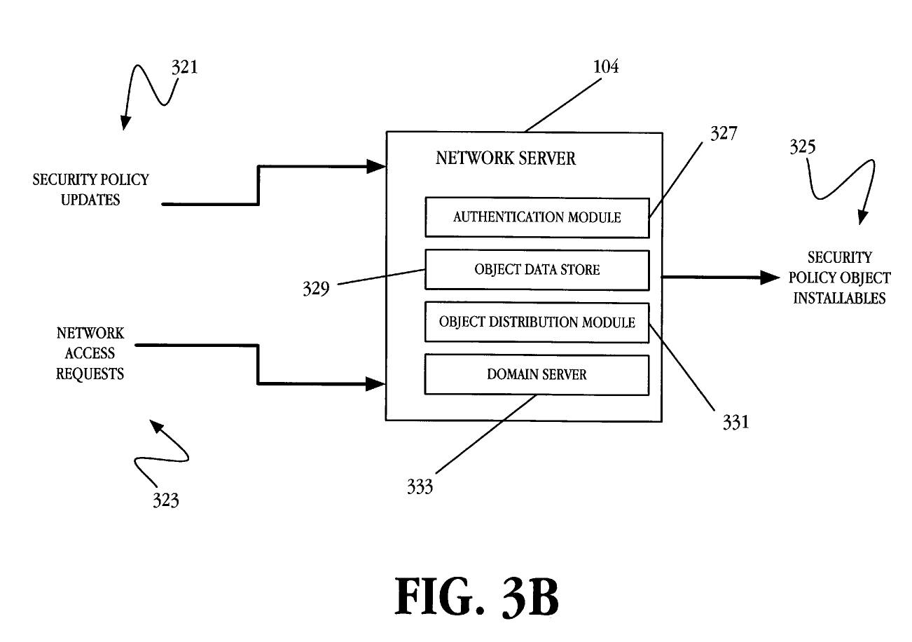

FIG. 3A shows a block diagram of an apparatus for distribution of security policy objects on a client network. The network server 104 receives one or two inputs. In one embodiment, the network server 104 receives security policy object updates 321 as an input. In a second embodiment, the network server 104 receives network access requests 323 from one or more client workstations 110 as an input. In another embodiment, the network server 104 receives both security policy object updates 321 and network access requests 323 as inputs. Using these inputs, the network server 104 configures and sends to the one or more client workstations 110 one or more security policy object installables 325.

As discussed above, the security policy server 102 outputs a security policy updates to one or more network servers at one or more client networks. The security policy updates 321 are received by the network server as an input, in one embodiment. In such an arrangement, the security policy updates 321 depicted in FIG. 3A correspond to the security policy updates 205 depicted in FIG. 2A and FIG. 2B. In an alternate embodiment, the security policy updates 321 are generated at the network server 104 itself. In such an arrangement, the functionalities described above with respect to the security policy server 102 are performed by the network server. On example where such an arrangement may be useful is in the case of a large client network. In such a situation, the computer support staff may be large enough to dedicate a person to the maintenance and update of security policies for the client workstations.

In addition to the security policy updates 321, the network server 104 also receives network access requests from one or more client workstations. Each computer that is connected to the client network generates a network access request. In one embodiment, the computer generates a domain services request. In another embodiment, the computer generates a request for an Internet Protocol (IP) address in the form of a Dynamic Host Control Protocol (DHCP) request. In another embodiment, the computer has a manually assigned IP address. In such an example, the computer is typically configured to ensure that such an EP address is not being used by any other device on the network. Two methods of determining this is through the use of Address Resolution Protocol (ARP) messages or Authentic Address Resolution Protocol (AARP). In yet another embodiment, the computer does not directly request network access through the network server 104. Such might be the case were a malicious user to place an unauthorized computer on the client network to utilize the network resources of the client network. In such an example, the network server may be configured to act as a router for the entire client network such that all network traffic passes through the network server. The network server, in this example, could watch the network traffic passing through and noticing a computer that it unrecognized, may send a challenge to the computer equivalent to the authentication challenge sent to any computer requesting access to the network. Through such functionality, all computers using the resources of the client network would be required to authenticate to the network server.

The network server 104, is additionally configured to send to the computer requesting network access an installable security policy object. The security policy object, in one embodiment, is a software module configured to be installed at the client workstation and to operate as a trusted application providing mediation services between hardware devices and software applications requesting access to the hardware devices, including, but not limited to the operating system. Hardware devices include, without limitation, network interface devices, output devices, input devices, storage devices and the like. Mention of specific examples is only meant to be illustrative and not to be taken in a limiting sense as hardware device, within the context of the present discussion, is considered to be any device that may represent a security risk if used by a software application or a user of the computer. Software applications include, without limitation, the operating system software itself, applications launched and monitored by the operating system software, user applications and the like. The security policy object is configured to intercept any calls to the hardware device and determine if the access requested is allowed within the implemented security policy.

FIG. 3B shows a more detailed block diagram of an apparatus for distribution of security policy objects on a client network. As discussed above with respect to FIG. 3A, the network server receives either security policy object updates 321 from a security policy server 102, network access requests 323 from one or more client workstations 110, or both, as inputs and outputs to the one or more client workstations 110 one or more security policy object installables. In an embodiment, the network server 104 includes an authentication module 327, a security policy object data store 329 and a distribution module 331. In a further embodiment, the network server 104 additionally includes a domain server 333 module.

In an embodiment, the authentication module 327 receives the network access requests from the client workstations and performs operations intended to authenticate either the client workstation itself or the identity of the user of the client workstation. In the former example, the client workstation may be a shared service of more then one user, such as a networked printer. The networked printer, in this example, needs access to one or more network services in order to perform its intended function. Every time the networked printer is initialized, the hardware identity of the networked printer would need to be authenticated. The hardware identity would be used to determine the proper security policy object to install at the networked printer, in an embodiment. Other authentication methods may be used, as are well known in the art, such as challenge-reply authentication, with respect to workstation itself. In the latter example, the user of the workstation would authenticate their identity with the security policy server through the use of the authentication module. Any suitable authentication method may be used. Some examples of suitable authentication methods include username/password authentication, biometric authentication, security tokens, and the like. Authentication methods for a user can generally be broken down into three categories: something the user is (such as biometric authentication, fingerprint, retina, or DNA scan); something the user has (such as a security token, dongle, RFID device, and the like); or something the user knows (such as passwords or pass phrases).

In an embodiment, the security object data store 329 is configured to receive security policy objects and store them for retrieval and distribution by the object distribution module. The security object data store 329 is additionally configured to receive updates to the security policy objects and update the stored security policy objects accordingly. This may include modifying the software code contained within the security policy object, or replacing in its entirety a security policy object. The security policy object, as discussed above is an installable software object that is configured to act as an intermediary between software applications and hardware devices. The security object data store 329 may be implemented in any available database or software module that can provide the functionality as outlined here.

In an embodiment, the object distribution module 331 is configured to retrieve the security policy object from the security policy object data store 329 and send the security policy object to a client workstation that has authenticated to the authentication module 327.

In an embodiment, the network server 104 additionally includes a domain server 333. The domain server 333 provides domain services to one or more computers on the client network. In the context of a homogenous Windows network, the domain server 333 is the server device that maintains a central database (known as Active Directory) that contains user accounts and security information for the resources available on the client network. Each user, including shared network devices, has a unique identifier associated with them and through the use of this unique identified access to resources on the client network can be given. In an embodiment, the domain server 333 is also referred to as a domain controller. The domain server 333, in another embodiment, is configured to manage all security-related aspects of a user and their domain interactions through the user of the security policy objects discussed above.

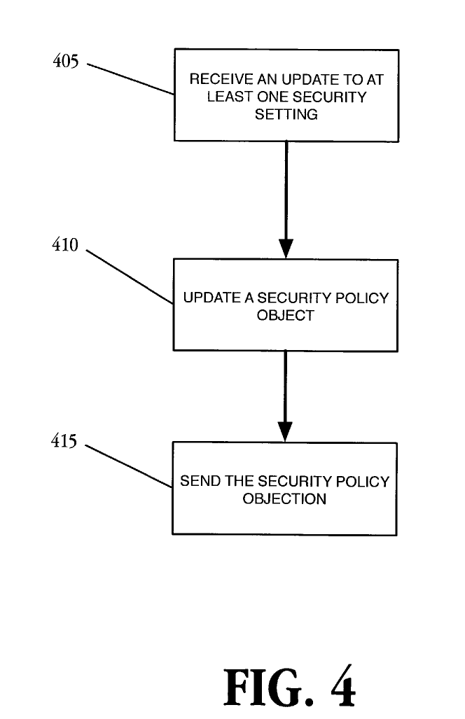

FIG. 4 shows a flowchart of a method of providing centralized security policy management to one or more client networks, in accordance with an example embodiment. In an embodiment, the operations described here with respect to FIG. 4 are carried out on a centralized server, such as the security policy server 102 described above.

At block 405, an update to at least one security policy setting for at least one user on a subscribed network is received from an agent of the subscribed network. The subscribed network, in an embodiment, is a client that has entered into a service agreement with the operator of the security policy server 102. This service agreement is a contract between the operator and the client that the operator shall maintain the security policy settings and provide updates to those settings in accordance with the client's wishes and information that the operator receives from other sources. The other sources include, without limitation, security updates, security alerts, and the like. Information received from other sources may cause the operator to need to update the security policy settings of workstations at the client network. One example of such an occurrence may be a newly discovered security vulnerability in a web browser. In this example, it may be necessary to update the security policy to restrict the web browser from doing the sorts of operations that expose the security vulnerability. Additionally, the agent of the subscribed network may be provided the ability to update the security policy settings. In the context of a small network, this is an efficient way for someone inexperience in security administration to implement very sophisticated and granular security at their network. For example, the agent, using a graphical user interface can adjust security levels for various users in a graphic way, in which the agent need not be well versed in the underlying operations needed to implement those policies. The agent could set policies for each user at the client network individually, or may choose to group more than one user together into a group and then set security policies for that group.

At block 410, the server updates and stores a security policy object using the update received from the agent in block 405. In one embodiment, this may be receiving the update from the agent and configuring new security policy objects for the client network. In such an example, a template security policy object may be retrieved from a data store, updated using the update, and then stored as a security policy object specific to that client network. In an alternate embodiment, the update is used to then update a security policy object specific to that client network that has been previously stored.

At block 415, the updated security policy object is sent to a network server on the subscribed network. In one embodiment, the network server is the network server 104 described above. The updated security policy object may be sent on any suitable schedule. In one embodiment, the updated security policy object is sent immediately following operations to update the security policy object. In an alternate embodiment, the updated security policy object is sent on a schedule that is indicative of a subscription level of the subscribed network. In such an arrangement, client network may wish to reduce the costs associated with security updates and chooses to only receive security policy updates on a weekly, daily or some other period, basis. Another client network may wish to receive the updates on a more regular basis and can be charged a higher subscription price. In a further embodiment, the updates are sent based on the severity level of the situation that prompted the update. An example would be a security vulnerability that is determined to be highly critical. In such a situation, notwithstanding any subscription level, the update may be sent out almost immediately. Another example may be a change in the status of a user on the subscribed network that has to take place immediately, such as a user taking over the duties over another due to an unexpected illness.

In an embodiment, the security policy object is a software object that is configured to be installed at a client workstation or hardware device and acts as an intermediary between one or more software applications and the one or more hardware devices. In such an arrangement, it may become necessary to periodically update the actual software object itself based on additional software development in order to provide more functionality to the software object, or increased stability or performance.

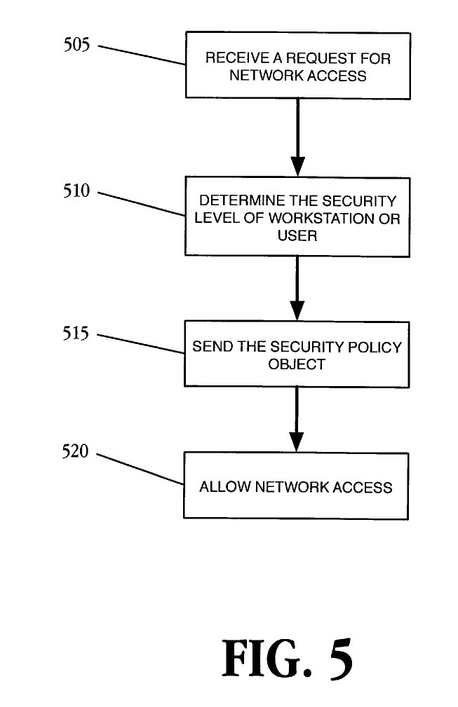

FIG. 5 shows a flowchart of a method of providing network services and tailored security objects to one or more client workstations on a client network, in accordance with an example embodiment. In an embodiment, the operations depicted in FIG. 5 are carried out on a server on a client network, such as the network server 104 described above.

At block 505, the network server receives a request from a client workstation. The request may include, without limitation, a request for network services, an authentication request message, a request for network access, or a network communication to another entity intercepted by the network server. The request may include an authentication request from a user that contains information sufficient to uniquely identify the user. The request may alternately include information unique to a hardware device sufficient to uniquely identify the hardware device.

At block 510, the security level of the client workstation is determined. In one embodiment, the security level of the workstation is determined after the workstation itself is authenticated without any data input by a user. Such an arrangement may be useful when the workstation is a shared network resource, such as a networked printer. In an alternate embodiment, the security level is determined based on the user logging into the workstation. The user's own security level, maintained by the network server is used to determine their allowed security level. In yet another embodiment, an unknown workstation and/or user attempts to access the network. In such an example, the security level is determined to be not allowed. However, a further challenge may be sent to the user or the workstation itself. The challenge may request further information about the user or alternate authentication means to identify the user as a trusted user. The challenge may additionally include a request to allow the installation of a security policy object on the workstation. Failure to allow the installation will result in network access being denied to the user or the workstation itself. Through such an arrangement, the network can be configured to allow, using some default security level, minimal network access to workstations being brought onto the network by contractors, customers, visitors, and the like.

At block 515, the security policy object is sent to the workstation. However, in the case of the security policy object being sent as part of the authentication challenge of an unknown workstation or user as discussed above, the operation at block 515 may be omitted. The security policy object that is sent to the workstation is determined by the security level of the user or the workstation. The security policy object may, in a first embodiment, install as a software object configured to act as an intermediary between software applications and one or more hardware devices. In a second embodiment, the security policy object merely configures a previously installed security policy object. In such an arrangement, network traffic may be minimized with the knowledge that that particular workstation in use has previously been provided a security policy object.

At block 520, further network access to the network is allowed for the workstation based on the security level. The security level as determined above, is a representation of a security policy in affect for the user or the client workstation, or both.

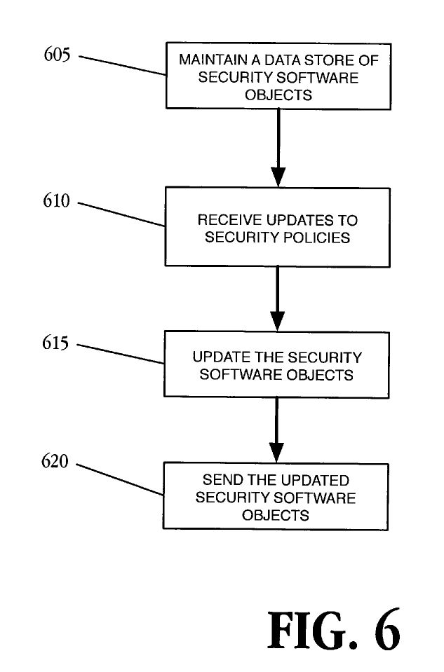

FIG. 6 shows a flowchart of a method of providing tailored centralized security policy management to one or more client networks, in accordance with an example embodiment. In an embodiment, the operations depicted with respect to FIG. 6 are carried out on a centralized server, such as the security policy server 102 depicted above.

At block 605, the centralized server maintains in a data store one or more security software objects. Discussion will be made with reference to a single client network, one or more users on the client network and one or more workstations on the client network. However, it should be understood that in operation, the centralized server would maintain data stores, either separate or combined, for many client networks. As discussed above, the security software objects are configured to act as an intermediary between software applications and one or more hardware devices. The security software objects additionally are configured to implement on or more security policies at a workstation. For example, if User Bob is the user at Workstation Beta, a security policy specific to User Bob/Workstation Beta is in effect. The security policy may state that at Workstation Beta no removable media may be used. The security policy for User Bob may state that User Bob can only use email, a client application to do financial accounting and a web browser. The Security policy may additionally state that User Bob is restricted from viewing one or more web sites. All of these policies are implemented in the security software object that is stored in the data store. When sent to the workstation, as detailed below, the security software object will implement these policies. In this example, when User Bob logs into Workstation Beta he will have email access, access to a financial accounting program, access to a web browser (but restricted from some sites) and not be able to use any removable media. Any action by User Bob or Workstation Beta that is outside this list is denied. As will be understood by those skilled in the art, discussion of specific policies here is only meant to be illustrative and not meant to be limiting, as the possible permutations and configurations of security policies are limitless.

Periodically, at block 610, the centralized server will receive updates to the one or more security policies. These updates may take the form of an agent of the client network logging into the centralized server to affect a change to policies, in one embodiment. For example, User Bob may have been promoted and now needs access to a personnel evaluation application. The agent for User Bob's client network would log in and change the security policy effective for User Bob to allow him access to the personnel evaluation program. The updates may also take the form of an operator of the centralized server responding to other information, such as security bulletins or newly discovered exploits, in another embodiment. For example, a specific web browser has been determined to contain a critical security flaw. In this example, the operator of the centralized server would be apprised of the flaw, and will access the security policies and modify them so that that specific web browser is not allowed to perform the operations that expose the flaw, or disallow the operation of that specific web browser altogether.

At block 615, the update to the one or more security policies will be affected by updating the stored one or more security software objects to implement that update. At block 620, the updated one or more security software objects will be sent to a network server at the client network. The network server at the client network is further configured to distribute the updated security software object to one or more workstations on the client network. In one embodiment, the updated one or more security software objects are sent periodically. In an alternate embodiment, the updated one or more security software objects are sent based on a previously agreed upon service level agreement.

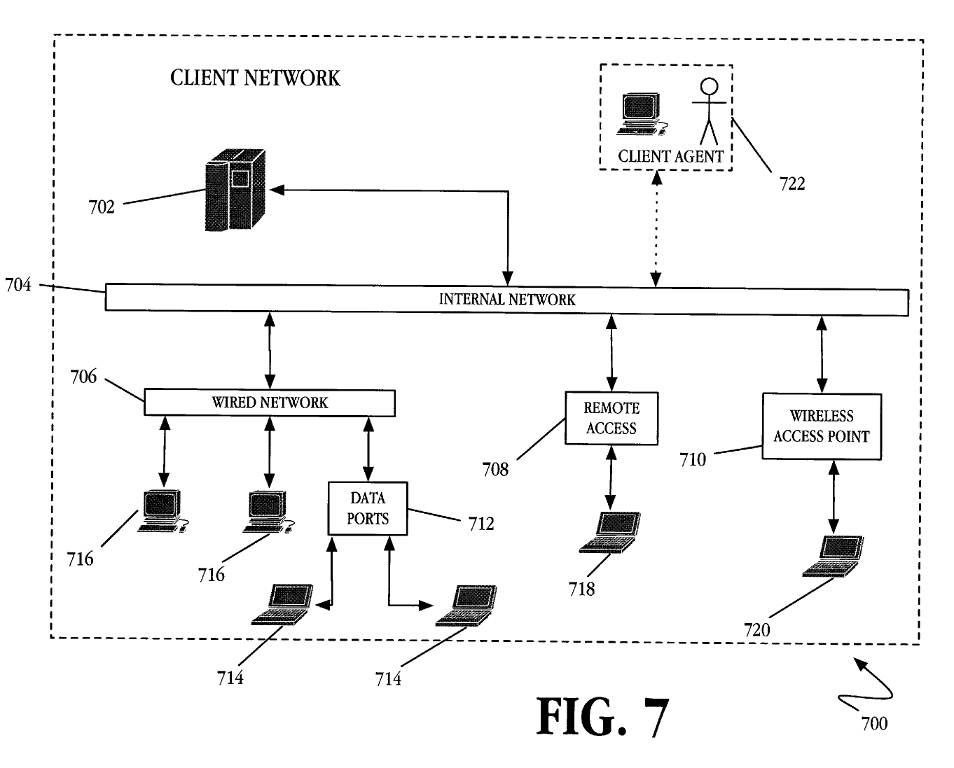

FIG. 7 shows a block diagram of a client network system, in accordance with an example embodiment. Operations and apparatus have been described in a general manner with respect to the updating and maintenance of security policy objects on one or more client workstations. A more detailed discussion regarding an exemplary client network can be made with reference to the apparatus and methods previously discussed.

The system 700 depicted in FIG. 7 is a simplified representation of a client network. The client network has a domain server 702 that provides domain services to the client network, and also provides connectivity to the Internet at large. The domain server 702 is coupled to the devices on the client network through an internal network 704. The internal network 704 represents the totality of access methods through which a computer can gain access to the domain server 702. Three methods are depicted in FIG. 7, a wired network 706, remote access 708 and wireless access point 710. The wired network 706 has one or more data ports 712 through which a computer access the internal network. The data ports 712 in FIG. 7 depict laptop computers 714 connected to them as an illustration, but as will be well understood, the desktop computers 716 in FIG. 7 will access the wired network 706 through a similar mechanism. However, for the purpose of illustration, discussion of differing connection methods need to be made, and though the desktop computers 716 are coupled through a data port to the wired network 706, it will be simplified in the present discussion that they are directly connected to the wired network.

The desktop computers 716 are used by one or more users and when the desktop computers 716 are initialized and a user logs in, an authentication request will be transmitted to the domain server 702. The domain server 702 determines the security level of the user and through the security level determines the one or more security policies in affect for the user and the workstation. Using this information the domain server retrieves a security software object for that workstation and sends it to the workstation which is then installed at the workstation and implements the one or more security policies in affect. The laptop computer 714, when connected to the data port, will initiate similar operations as the users of those laptop computers are known to the domain server in this example.

Remote access 708 connectivity provides a connection to remote computers 718 across the network at large. This may be through the use of a modem pool, or a VPN server. In any regard, the computer connecting in this method will be regarded as being on the client network, for the purposes of discussion. As the user connecting through this mechanism will be known to the domain server, otherwise access through this method would not be granted, the operations to retrieve and install the security policy object are similar to those discussed above.

One of the more insecure aspects of computer networks is the use of a wireless access point 710. The wireless access point 710 provides flexibility to users on the client network, but anyone with the proper hardware can detect and possibly connect to the wireless access point 710. Operations for an unauthorized user and/or computer will be made with reference to this type of connection. However, any of the other network connection methods have possible insecurities, such as an open data port.

The user trying to connect to the wireless access point 710 will begin to generate network messages. These messages will be received on the internal network. A savvy user may be able to configure the wireless computer 720 to operate without requesting services from the domain server 702. In such an event, access to the internet at large will still be monitored by the domain server 702, as set forth above. The network messages generated by the wireless computer 720 will be received by the domain server 702 as they attempt to gain access to the internet at large. An authentication message will be sent to the wireless computer 720. Three scenarios flow from this message being sent. The first is that of the wireless computer 720 not being able to effectively parse the message and display the authentication request to the user. In such a scenario, further network communications from the wireless computer 720 will be denied. In a second scenario, the wireless computer 720 receives the request and is able to display such to the user. The authentication request to the user may include a disclaimer that in return for network access, a software object will be installed on the user's computer. Additionally, the request may authenticate the identity of the user, through any suitable means. In this scenario, the user declines to authenticate themselves and/or allow the installation of the software. The domain server 702 would in turn deny further network access by the wireless computer 720 as in the first scenario. The third scenario is similar to the second scenario, but the user does authenticate themselves and/or allow the installation of the software. In this scenario, the security policy object installs on the wireless computer and performs the functions as outlined above.

One other user is depicted in FIG. 7 that hasn't been discussed. That is the client agent 722. The client agent 722 is a special user, but as shown in FIG. 7 is connected to the client network through the internal network as previously discussed. The client agent 722 is that user who is allowed to make changes to the security policies implemented on the client network. They may do this through a network connection that passes through the domain server, but may also do it through a phone conversation. The updates to the security policy may be sent to a centralized server, as discussed above, or may be sent directly to the domain server 702. In the latter example, the domain server 702 would be configured to perform the functions described above with respect to the security policy server 102.

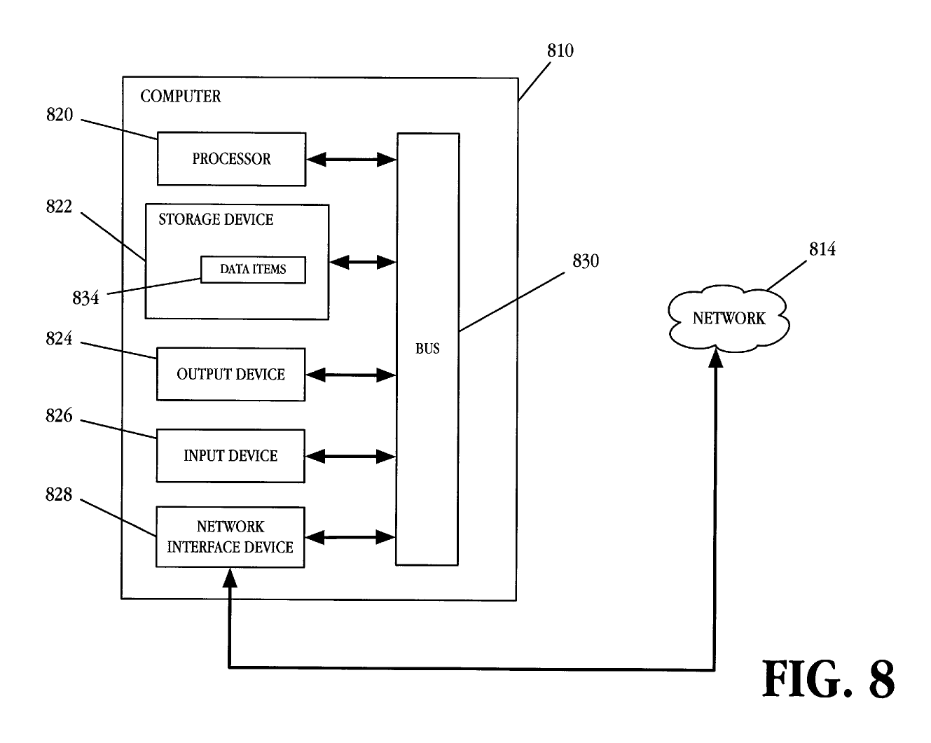

FIG. 8 shows a block diagram of a machine including instructions to perform any one or more of the methodologies described herein. A system 800 includes a computer 810 connected to a network 814. The computer 810 includes a processor 820, a storage device 822, an output device 824, an input device 826, and a network interface device 828, all connected via a bus 830. The processor 820 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 820 executes instructions and includes that portion of the computer 810 that controls the operation of the entire computer. Although not depicted in FIG. 6, the processor 820 typically includes a control unit that organizes data and program storage in memory and transfers data and other information between the various parts of the computer 810. The processor 820 receives input data from the input device 826 and the network 814, reads and stores code and data in the storage device 822, and presents data to the output device 824.

Although the computer 810 shows only a single processor 820 and a single bus 830, the present invention applies equally to computers that may have multiple processors, and to computers that may have multiple busses with some or all performing different functions in different ways.

The storage device 822 represents one or more mechanisms for storing data. For example, in an embodiment, the storage device 822 includes one or more memory devices such as, read only memory (ROM), random access memory (RAM), magnetic disk storage media, optical storage media, flash memory devices, and/or other machine-readable media. In other embodiments, any appropriate type of storage device may be used. Although only one storage device 822 is shown, multiple storage devices and multiple types of storage devices may be present. Further, although the computer 810 is drawn to contain the storage device 822, it may be distributed across other computers, for example on a server.

The storage device 822 includes a controller (not shown) and data items 834. The controller includes instructions capable of being executed on the processor 820 to carry out the functions of the present invention, as previously described above. In another embodiment, some or all of the functions of the present invention are carried out via hardware in lieu of a processor-based system. In one embodiment, the controller is a web browser, but in other embodiments, the controller may be a database system, a file system, or may include any other functions capable of accessing data items. Of course, the storage device 822 may also contain additional software and data (not shown), which is not necessary to understanding the invention.

Although the controller and the data items 834 are shown to be within the storage device 822 in the computer 810, some or all of them may be distributed across other systems, for example on a server and accessed via the network 814

The output device 824 is that part of the computer 810 that displays output to the user. The output device 824 may be a liquid crystal display (LCD) well-known in the art of computer hardware. But, in other embodiments the output device 824 may be replaced with a gas or plasma-based flat-panel display or a traditional cathode-ray tube (CRT) display. In still other embodiments, any appropriate display device may be used. Although only one output device 824 is shown, in other embodiments any number of output devices of different types, or of the same type, may be present. In an embodiment, the output device 824 displays a user interface.

The input device 826 may be a keyboard, mouse or other pointing device, trackball, touchpad, touch screen, keypad, microphone, voice recognition device, or any other appropriate mechanism for the user to input data to the computer 810 and manipulate a user interface. Although only one input device 826 is shown, in another embodiment any number and type of input devices may be present.

The network interface device 828 provides connectivity from the computer 810 to the network 814 through any suitable communications protocol. The network interface device 828 sends and receives data items from the network 814.

The bus 830 may represent one or more busses, e.g., USB (Universal Serial Bus), PCI, ISA (Industry Standard Architecture), X-Bus, EISA (Extended Industry Standard Architecture), or any other appropriate bus and/or bridge (also called a bus controller).

The computer 810 may be implemented using any suitable hardware and/or software, such as a personal computer or other electronic computing device. Portable computers, laptop or notebook computers, PDAs (Personal Digital Assistants), pocket computers, appliances, telephones, and mainframe computers are examples of other possible configurations of the computer 810. For example, other peripheral devices such as audio adapters or chip programming devices, such as EPROM (Erasable Programmable Read-Only Memory) programming devices may be used in addition to, or in place of, the hardware already depicted.

The network 814 may be any suitable network and may support any appropriate protocol suitable for communication to the computer 810. In an embodiment, the network 814 may support wireless communications. In another embodiment, the network 814 may support hard-wired communications, such as a telephone line or cable. In another embodiment, the network 814 may support the Ethernet IEEE (Institute of Electrical and Electronics Engineers) 802.3x specification. In another embodiment, the network 814 may be the Internet and may support IP (Internet Protocol). In another embodiment, the network 814 may be a local area network (LAN) or a wide area network (WAN). In another embodiment, the network 814 may be a hotspot service provider network. In another embodiment, the network 814 may be an intranet. In another embodiment, the network 814 may be a GPRS (General Packet Radio Service) network. In another embodiment, the network 814 may be any appropriate cellular data network or cell-based radio network technology. In another embodiment, the network 814 may be an IEEE 802.11 wireless network. In still another embodiment, the network 814 may be any suitable network or combination of networks. Although one network 814 is shown, in other embodiments any number of networks (of the same or different types) may be present.

The embodiments described herein may be implemented in an operating environment comprising software installed on any programmable device, in hardware, or in a combination of software and hardware.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An apparatus for distributing security policy objects to one or more client networks, the apparatus comprising:
a security object server configured to retrieve one or more security policy objects and modify the one or more security policy objects;
a software data store to store one or more security policy objects; and
a client policy management module coupled to the security object server to receive updates to the one or more security policy servers and to send instructions to the security object server, the instructions intended to modify the one or more security policy objects using the update.

2. The apparatus of claim 1, further comprising:
a server management module to receive updates to the one or more security policy objects.

3. The apparatus of claim 2, wherein the updates to the one or more security policy objects are software updates to the one or more security policy objects.

4. The apparatus of claim 2, wherein the updates to the one or more security policy objects are updates to the one or more security policies that have equal applicability to one or more client networks.

5. The apparatus of claim 1, wherein the one or more security policy objects include installable software packages which, when received by a client workstation, are configured to be installed on the client workstation without any intervention by a user.

6. The apparatus of claim 5, wherein the one or more security policy objects are executed as trusted software applications and act as an intermediary between a software application and one or more hardware devices on the client workstation.

7. The apparatus of claim 1, wherein the security object server is configured to distribute the one or more security policy objects to a network server on a client network.

8. The apparatus of claim 7, wherein the one or more security policy objects are distributed based on a schedule indicative of a service level agreement for the client network.

9. An apparatus for providing security policy objects to one or more client workstations comprising:
an authentication module to receive one or more network access requests from one or more client workstations;
an object data store to store one or more security policy objects; and
an object distribution module to retrieve and distribute the one or more security policy objects to the one or more client workstations.

10. The apparatus of claim 9, further comprising a domain server, the domain server to provide domain services to the one or more client workstations.

11. The apparatus of claim 10, wherein the domain server is configured to manage all security-related aspects of a user and their domain interactions.

12. The apparatus of claim 9, wherein the one or more security policy objects are received from a security policy server.

13. The apparatus of claim 9, wherein the one or more security policy objects are received on a schedule indicative of a service level agreement.

14. A method of providing security policy objects to a subscriber, the method comprising:
receiving, from an agent of a subscribed network, an update to at least one security policy setting for at least one user on the subscribed network;
updating and storing a security policy object using the received update; and
sending the updated security policy object to a network server on the subscribed network.

15. The method of claim 14, wherein the updated security policy object is sent on a schedule indicative of a subscription level of the subscribed network.

16. The method of claim 14, wherein the updated security policy object is sent on a regular schedule.

17. The method of claim 14, wherein the updated security policy object is sent immediately following the update.

18. The method of claim 14, wherein the network server includes the following software modules: authentication module, object data store and an object distribution module.

19. The method of claim 14, wherein the object distribution module is configured to distribute the updated security policy object to one or more client workstations based on the at least one security policy.

20. A method of delivering security policy objects to client workstations, the security policy objects individually configured to implement a unique security level, the method comprising:
receiving a request from a client workstation at a network server;
determining if the client workstation is an allowed client workstation;
sending an authentication request to the client workstation if the client workstation is not an allowed client workstation;
sending a security policy object to the client workstation if the client workstation is an allowed client workstation; and
installing the security policy object on the client workstation.

21. The method of claim 20, wherein the authentication request is configured to validate the user of the client workstation.

22. The method of claim 21, further comprising sending the security policy object is sent to the client workstation if the user is validated.

23. The method of claim 20, wherein the security policy object is an installable software packages which, when received by a client workstation, are configured to be installed on the client workstation without any intervention by a user.

24. The method of claim 23, wherein the security policy object is executed as trusted software applications and act as an intermediary between a software application and one or more hardware devices on the client workstation.

25. A method of updating security policy objects on a network services server, the method comprising:
maintaining in a data store one or more security software objects for a client network, each of the one or more security software objects configured to implement one or more security policies at a client workstation computer on the client network;
receiving updates to the one or more security policies;
updating the one or more security software objects such that the updated security software object is configured to implement the updated one or more security policies; and
periodically sending the updated one or more security software objects to a network services server at the client network, the network services server configured to distribute the one or more security software objects to one or more client workstations on the client network.

26. A system for distributed security policy management, the system comprising:
a security policy server coupled to a local network server across a network, the security policy server to maintain one or more security policy objects and to distribute the one or more security policy objects to the local network server as required;
the local network server, the local server comprising the following software modules:
an authentication module to receive one or more network access requests from one or more client workstations;
an object data store to locally store the one or more security policy objects; and
an object distribution module to retrieve and distribute the one or more security policy objects to the one or more client workstations.

27. The system of claim 26, wherein the local network server further comprises a domain server, the domain server to provide domain services to the one or more client workstations.

28. The system of claim 26, wherein the security policy server comprises the following software modules:
a security object server to distribute to the local network server the one or more security policy objects;
a software data store to maintain a data store of the one or more security policy objects; and
a client policy management to provide a user interface to an agent of the local network, the user interface to allow the agent to update one or more security policies in regards to the local network.
